(19) United States
(12) Patent Application Publication
(10) Pub. No.: US 2005/0188297 A1
(43) Pub. Date: Aug. 25, 2005

(54) Multi-audio add/drop deterministic animation synchronization

(75) Inventors: Jeffrey L. Knight, St. Marys, KS (US); Shane W. Hill, St. Marys, KS (US); Michael E. Diesel, Saugus, MA (US); Peter J. Isermann, Rossville, KS (US); Richard T. Beck IV, Rossville, KS (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Automatic e-Learning, LLC, St. Marys, KS (US)

(21) Appl. No.: 11/016,552

(22) Filed: Dec. 17, 2004

Related U.S. Application Data
(63) Continuation-in-part of application No. 10/287,441, filed on Nov. 1, 2002.
(63) Continuation-in-part of application No. 10/287,464, filed on Nov. 1, 2002.
(63) Continuation-in-part of application No. 10/287,468, filed on Nov. 1, 2002.
(60) Provisional application No. 60/530,457, filed on Dec. 17, 2003.
(60) Provisional application No. 60/334,714, filed on Nov. 1, 2001.
(60) Provisional application No. 60/400,606, filed on Aug. 1, 2002.

(51) Int. Cl. G06F 17/00

(52) U.S. Cl. 715/500.1

(57) ABSTRACT

Techniques are provided for synchronizing audio and visual content. A multiple audio language product can be produced containing a single video file that is automatically synchronized to whichever audio the viewer selects. The audio streams and video streams are processed into a plurality of segments. If, for example, an audio stream is selected that corresponds to a particular language, which is not the original audio stream that the video was synchronized to, then the duration of each audio segment in the selected stream can be compared with the duration of each segment in the original audio stream. The number of frames in a segment of the video stream can be adjusted based on the comparison. If the playback duration of the selected audio segment is greater than the corresponding original audio segment, one or more frames in the video segment can be repeated. If the playback duration of the selected audio segment is less than the corresponding original audio segment, then one or more frames in the video segment can be dropped. In this way, video can be automatically synchronized, at run-time, to whichever audio the viewer selects.

### RELATED APPLICATIONS

This application claims the benefit of U.S. Provisional Application No. 60/530,457, filed on Dec. 17, 2003 and is a Continuation-in-Part of U.S. patent application Ser. Nos. 10/287,441, filed Nov. 1, 2002, 10/287,464, filed Nov. 1, 2002 and 10/287,468, filed Nov. 1, 2002, all which claim priority to Provisional Patent Application Nos. 60/334,714, filed Nov. 1, 2001 and 60/400,606, filed Aug. 1, 2002.

### BACKGROUND

Users of digital media content come from vast and diverse markets and cultures throughout the world. Accessibility, therefore, is an essential component in the development of digital media content because the products that can be accessed by the most markets will generally garner the greatest success. By providing a multiple audio language product, a far wider audience can be reached to experience the digital media presentation.

The conventional media development technology enables presentations to be developed in multiple languages. Computerized multi-media presentations, such as e-Learning, have been developed with narration. This narration may also be associated with on-screen, closed-caption text, and synchronized with video or animations, through programs such as Macromedia Flash tools. For the presentation to play in different languages, the video would typically need to be synchronized each audio track in the presentation. This can result in several different versions of the presentation, one for each audio track. Typically, for each audio track the presentation would need to be synchronized by manually adjusting the timing of the video (e.g., animation) to match the audio (or visa versa), resulting in audio and video that is synchronized; and thus has equal amounts of play time.

In general, after media content has been synchronized with audio, closed-caption script may be attached using time-codes. Time-codes, for example, may be specified in units of fractional seconds or video frame count, or a combination of these. The time-codes can provide instructions as to when each segment of closed-caption script is to be displayed in a presentation. Once computed, these time codes can be used to segment the entire presentation, perhaps to drive a visible timeline with symbols, such as a bull's-eye used between timeline segments whose length is proportional to the running time of the associated segment.

Once a presentation (e.g., movie, e-learning presentation, etc.) has had its visual media synchronized with its audio, it can be difficult to make changes that effect either the audio or video streams, without disrupting the synchronization. For instance, the substitution of new audio, such as a different human language, or the replacement of rough narration with professional narration, typically results in different run-time for the new audio track that replaces the old audio track, and thus, a loss of synchronization. Unfortunately, re-working the animations or video in order to restore synchronization is labor intensive, and consequently, expensive.

### SUMMARY

Due to the problems of the prior art, there is a need for techniques to synchronize video and audio. A multiple audio language product (presentation) can be produced containing a video stream that is automatically synchronized to whichever audio the viewer selects. Video to audio synchronization can be substantially maintained even though new audio streams are added to the presentation.

A system for synchronizing media content can be provided. A media segment has a media duration. A first audio segment corresponds to the media segment. The first audio segment has a first audio duration. A second audio segment corresponds to the media segment. The second audio segment has a second audio duration. A processor compares the first audio duration with the second audio duration. Based on the comparison, the media duration is adjusted to substantially equal the second audio duration.

The first audio stream can reflect an initial (draft) version of the audio. Alternatively, the first audio stream can be directed to a specific language. The second audio stream can reflect a final version of the first audio stream. Alternatively, the second audio stream can be directed to another language. For example, the first audio stream can correspond to a first language and the second audio stream can correspond to a second language.

A video stream can be initially synchronized to a first audio stream. The video stream and first audio stream are partitioned into logical segments, respectively. The end-points of the segments can be specified by time-codes. Closed-caption script can be assigned to each audio segment. Once the video stream has been synchronized to the first audio stream and the video stream and first audio stream have been partitioned into segments, the video stream can be quickly and easily synchronized, automatically, to any other audio streams that have been partitioned into corresponding segments. At run-time, for example, the video stream can be substantially synchronized to another audio stream. This can be accomplished by comparing the duration of the first audio stream with the second audio stream, and adjusting the duration of the video stream based on this comparison. In particular, the duration of a segment in the first audio stream is compared with the duration of a corresponding segment in the second audio stream. If the duration of the first segment is greater than the duration of the second segment, then frames from the media stream are dropped at regular intervals. If the duration of the first segment is less than the duration of the second segment, then frames in the media stream are repeated at regular intervals.

The video stream (e.g. media stream) and the first and second audio streams can be processed into a plurality of media and audio segments, respectively. Each media segment, for example, can correspond to a sentence in the audio and closed-caption text, or the segment can correspond to a “thought” or scene in the presentation. The media and audio streams can be defined into segments using time-codes. The time-codes may include information about the duration of each segment. The durational information may be stored in an XML file that is associated with the presentation.

The media stream in the presentation can be synchronized with the first audio stream at development time. Closed-caption text can be time-coded to closed-caption text and the first audio stream (and thus to the associated video). Even though the media stream has not been substantially synchronized to the second audio stream, at run-time, for example, a viewer may select the second audio stream to be played in the presentation. The video stream can be automatically substantially synchronized to the second audio stream in the presentation with no manual steps. In particular, each segment in the media stream can be substantially synchronized to each segment in the second audio stream by comparing the respective duration of a segment from the first audio stream and a corresponding segment from the second audio stream and by adjusting the duration of the corresponding media segment based on the comparison. Thus, a single video stream may be played and substantially synchronized at run-time any selected audio stream from the plurality audio streams.

If, for example, the duration of the second audio segment is greater than the duration of the first audio segment, then additional frames can be added to the corresponding media segment. By adding one or more frames to the media segment, the duration of the media segment can be increased. One or more frames can be added to the media segment by causing the media segment to repeat (or copy) a few of its frames. Every Nth frame of the media segment can be repeated or copied to increase the duration of the media segment. If, for instance, the audio segment is approximately ten percent greater than the duration of the first audio segment, then every tenth frame of the media segment can be repeated.

If, for example, the duration of the second audio segment is less than the first audio segment, then one or more frames from the media segment can be removed. By removing one or more frames from the media segment, the duration of the media segment can be decreased. Every Nth frame from the media segment can be deleted to decrease the duration of the media segment. If, for instance, the duration of the second audio segment is approximately twenty percent less than the duration of the first audio segment, then every twentieth frame from the media segment can be dropped.

The media segment can be modified by adding or dropping frames at anytime. For example, the media segment can be modified by a processor at run-time, such that the media segment includes copied or deleted frames. In this way, the media segment can be substantially synchronized with the audio segment at run-time (play-time). In another embodiment, frames can be added to or deleted from the media segment at development time, for example, using a processor. In this way, as the audio streams are processed in connection with the media segment, synchronization can be preserved by automatically modifying the media segment to compensative for any losses or gains in overall duration.

The media segment and first and second audio segments can be defined as segments using time-codes. The media and audio segments reflect a portion of a file, respectively (e.g., a portion of a video file, first audio file, second audio file). The media and first and second audio streams can be segmented with time-codes. The time-codes can define the segments by specifying where each segment begins and ends in the stream. In addition, markers may be inserted into the audio and media segments. These markers may be used to determine which segment is currently being processed. When a marker is processed, it can trigger an event. For example, at run-time (e.g., upon playback), if a marker is processed, an event can be fired.

Developer tools can be provided for creating a presentation that includes the synchronized media and audio streams. The developer tools can include a time-coder, which is used to associate closed-caption text with audio streams. The developer tools can include an electronic table having rows and columns, where the intersection of a respective column and row defines a cell. Cells in the table can be used to specify media, such as an audio file, time-code information, closed-captioning text, and any associated media or audio files. Any cells associated with the audio file cell can be used to specify the time-coding information or closed-captioning text. For example, a first cell in a column may specify the file name of an audio file, and time-code information associated with the audio file may be specified in the cells beneath the audio file cell, which are in the same column. The time-coding information may define the respective audio segments for the audio file. A cell that is adjacent to a cell with time-coding information that defines the audio segment can be used to specify media, such as closed-captioning text that should be presented when the audio segment is played. Further, the cells may also specify video segments (e.g. animations) that should be presented when the audio segment is played. In this way, video segments and closed-captioning text, and the relationships between them, may be specified using cells of a table. A developer, for instance, using the table can specify that a specific block of text (e.g., the closed-captioning text) should be displayed, while an audio segment is being played. The use of a cells in a table as a tool for developing the presentation facilitates a thought-by-thought (segment-by-segment) development process.

The contents of the electronic table can be stored in an array. For example, an engine, such as a builder, can be used to process the contents of the electronic table and store the specified media and time-coding information into one or more arrays. The arrangement of the cells and their respective contents can be preserved in the cells of the arrays. The arrays can be accessed by, for example, a player, which processes the arrays to generate a presentation. The builder can generate an XML file that includes computer readable instructions that define portions of the presentation. The XML file can be processed by the player, in connection with the arrays, to generate the presentation.

By processing portions of media streams into segments, a presentation can be developed according to a thought-by-thought developmental approach. Each segment (e.g., thought) can be associated with respective audio segment, video segment and block of closed-captioning text. The audio segment and closed-captioning text can be revised and the synchronization of the audio, closed-caption text and video segment can be computationally maintained. The durational properties of the video segment can be modified by adding or dropping frames. In this way, a multiple audio language product can be developed and the synchronization of audio/visual content can be computationally maintained to whichever audio the viewer selects.

### BRIEF DESCRIPTION OF THE DRAWINGS

The foregoing and other objects, features and advantages of the invention will be apparent from the following more particular description of embodiments of the invention, as illustrated in the accompanying drawings in which like reference characters refer to the same parts throughout the different views. The drawings are not necessarily to scale, emphasis instead being placed upon illustrating the principles of the invention.

FIGS. 1A-1B are diagrams of a development environment using a time-coder according to an embodiment of the invention.

FIG. 2A is a block diagram depicting the process of synchronizing media in a presentation according to an embodiment of the invention.

FIG. 2B is a block diagram depicting specific functions that occur with a dual media page load according to an embodiment of the invention.

FIGS. 3A-3B are diagrams depicting features of the time-coder controls.

FIG. 4 is a depiction of an animation control/status bar.

### DETAILED DESCRIPTION

Consider the situation, for example, where a developer creates a presentation that includes a video stream that is time-coded to an English audio stream. Later, the developer wants to revise the presentation so that instead of having an English audio stream, it has a Vietnamese audio stream. In the past, a developer in this situation, typically, a developer had to modify the video with the new Vietnamese audio, in order to ensure that the video and the new Vietnamese audio are substantially synchronized. The developer would have generally been required to synchronize to the video to the new Vietnamese audio even though the presentation was previously synchronized with the English audio stream. In accordance with particular embodiments of the invention, however, changes to the audio streams in a presentation can be made and the content of presentation can still be substantially synchronized.

A presentation can be developed that has a plurality of different audio streams that can be selected. One audio stream, the “first audio stream” can reflect an initial (draft) version of the audio. Alternatively, the first audio stream can be directed to a specific language, such as English. Another audio stream, the “second audio stream” can reflect a final version of the first audio stream. Alternatively, the second audio stream can be directed to a different language, such as Vietnamese. For example, the first audio stream can correspond to an English version and the second audio stream can correspond to the Vietnamese version.

A video stream can be substantially synchronized to a first audio stream, however, this can be difficult because it needs to be done manually. Once the media stream and the first audio stream are substantially synchronized, the media stream can be automatically synchronized to whichever audio stream a viewer may selects.

The first audio stream can be partitioned into logical segments, (such as thoughts, phrases sentences or paragraphs). The logical segments can be easily specified by, for example, time-codes to assign closed-caption script to each audio segment.

A second audio stream (such as a second language) can be created and easily partitioned into logical segments that have a one-to-one correspondence to, but with different duration than, the logical segments of the first audio stream. (If this was a different language, one might add closed-caption script in the new language.) It is desirable that the video be substantially synchronized with the second audio. The invention does this automatically, without difficultly. Once the video stream has been synchronized to the first audio stream and the first audio stream has been partitioned into logical segments, the video stream can be automatically synchronized to any other audio streams that have been partitioned into corresponding logical segments.

At run-time, for example, the video stream can be substantially synchronized to another audio stream. This can be accomplished by comparing the duration of the first audio stream with the second audio stream, and adjusting the duration of the video stream based on this comparison. In particular, the duration of a segment in the first audio stream is compared with the duration of a corresponding segment in the second audio stream. If the duration of the first segment is greater than the duration of the second segment, then frames from the media stream are dropped at regular intervals. If the duration of the first segment is less than the duration of the second segment, then frames in the media stream are repeated at regular intervals.

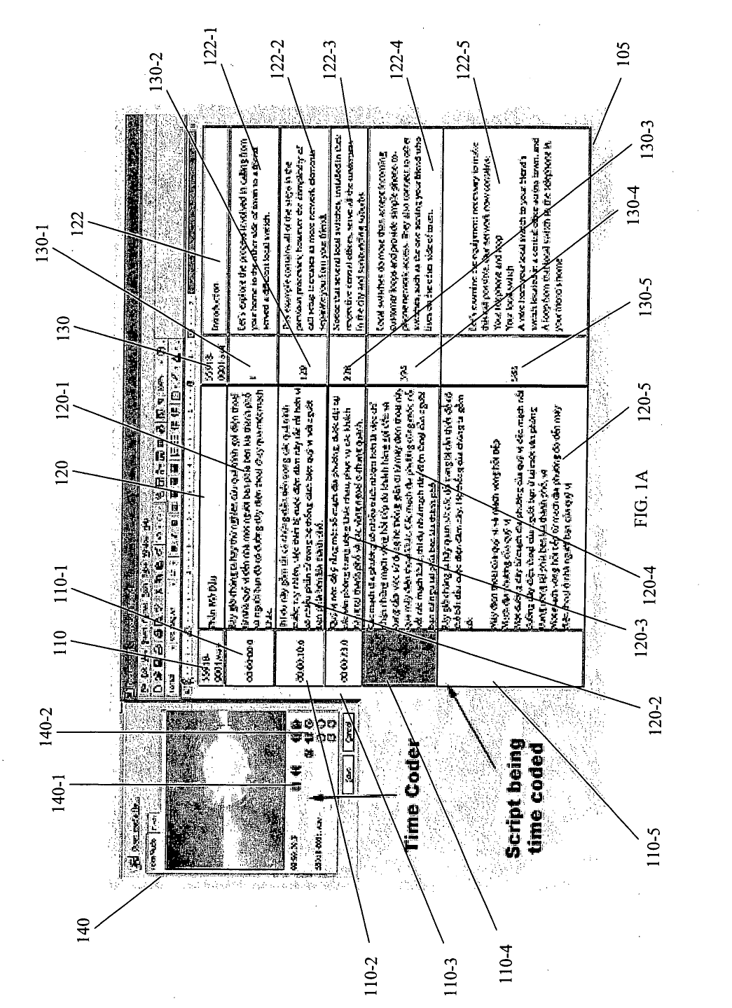

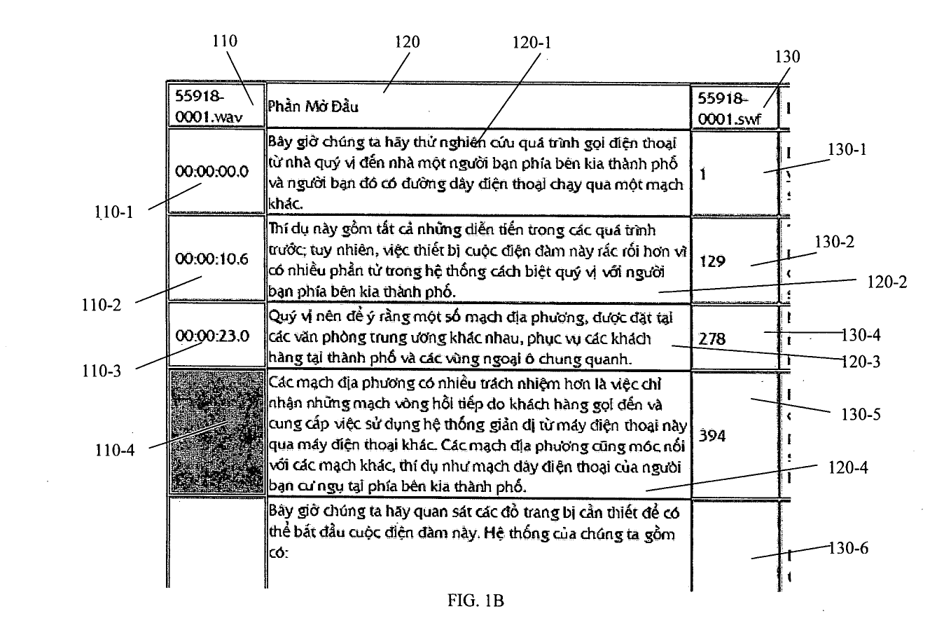

Closed-caption text can be time-coded to the audio at development time. FIGS. 1A-1B are diagrams of a development environment using a time-coder according to an embodiment of the invention. An electronic table 105 can be used to create the script for a presentation. The table 105 can be used to specify media and related time-coding information for the presentation. The time-coder 140 allows the developer to include video independently of audio, and vice versa. For example, an audio file, “55918-001.wav”, is specified in cell 110. The audio file 110 corresponds to the “second” audio file. Cells 110-1, . . . , 110-5 may be used to specify time-coding information that associates the closed-caption script in column 120 with the audio file 110. The video (animation) file and original, “first”, audio, “55918-001.swf”, is specified in cell 130. Cells 130-1, . . . , 130-5 may be used to specify time-coding information associating the closed-caption information in column 122 with the original audio file to which video file 130 had been already substantially synchronized.

In this example, file 130 could contain both the video and the original audio to which the video was already synchronized. However, due to current animation player limitations of not being able to play the animation and mute the audio, at development time, the English audio might be stripped out leaving only the video. The English audio (if needed) could be provided on a separate file (not shown.)

A developer can use the time-coder 140 to partition the second audio file into segments. The segments can correspond to thoughts or sentences, or paragraphs. For example, the media content can include the audio file 130, closed-captioned text 120, 122, and video file 130. To process the second audio file into segments, a developer can select one of the cells 110-1, 110-2, . . . , 110-5 under the audio file cell 110, and then start 140-1 and stop 140-2 the audio file 110 to define the audio segment.

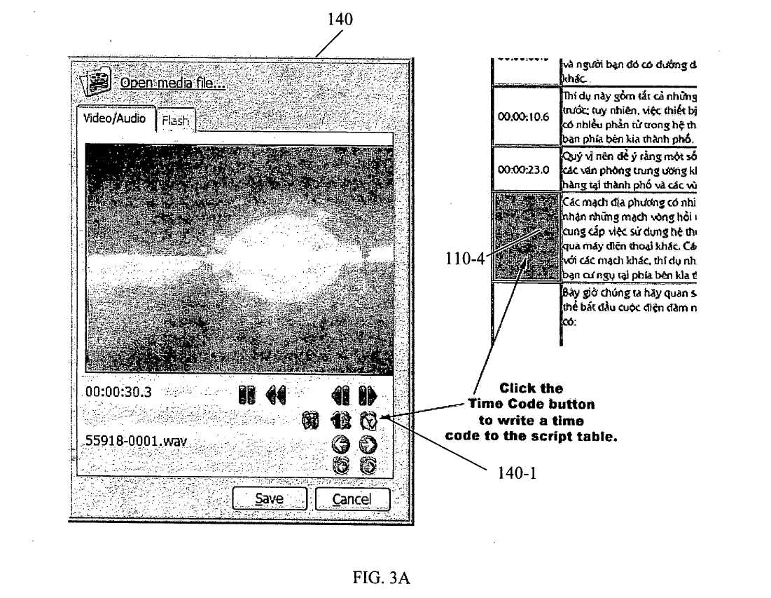

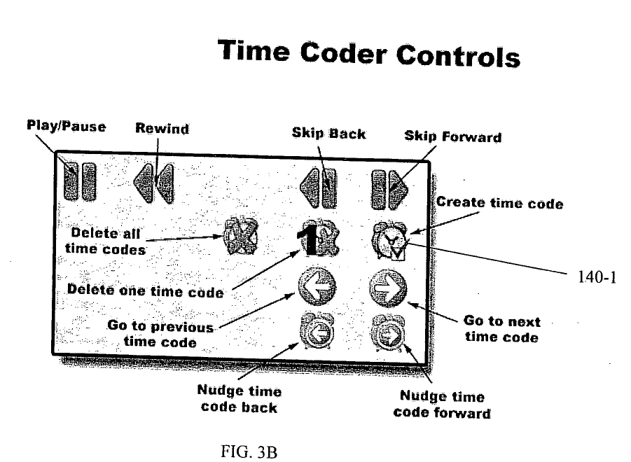

For example, cell 110-4 is a selected cell. The time-coder controls 140 can be used to indicate time-coding information that associates the closed-captioned text with the audio file 110 in the selected cell 110-4. FIGS. 3A and 3B are diagrams depicting features of the time-coder controls. The time-code button 140-2 can be pressed to indicate the end of the audio segment. The end of the audio segment can be determined by comparing the ending time-code with each marker that is inserted into the audio file until the maker is encountered that matches the time-code. The time-code information effectively defines the duration of the audio segment, and it is reflected in the selected cell.

Referring to FIGS. 1A and 1B, cells 110-1, 110-2 and 110-3 reflect the specified time-code information, which effectively defines each audio segment. The time-code information, for a windows media file, for example, can be a time-code format, which is broken down into HOURS:MINUTES:SECONDS:TENTHOFASECOND. Typically, the audio file 110 starts at 00:00:00:00 and then increases.

Closed-caption text 120-1, 120-2, 120-3 is associated with an audio segment 110-1, 110-2, 110-3, respectfully For example, the content of audio segment 110-1 can correspond to the sentence in closed-captioned text cells 120-1. In addition, a specific column in the table 105 can be associated with closed-captioned text of a particular language. In the example shown in FIGS. 1A and 1B, for instance, cells 120-1, 120-2, . . . 120-5 correspond to Vietnamese closed-captioned text and cells 122-1, 122-2, . . . , 122-5 correspond to English closed-captioned text. An audio segment, e.g. 110-1, is associated with the closed-caption text in its row, that is, Vietnamese closed-captioned text 120-1 and English closed-captioned text 122-1. At run-time, in the presentation, the audio segment 110-1 can be played and the Vietnamese 120-1 or English 122-1 subtitles can be displayed while the audio segment is playing.

The animation 130 is processed into segments 130-1, . . . , 130-5. The segments 130-1, . . . , 130-5 correspond to other media segments. For instance, animation segment 130-1 corresponds to blocks of closed-captioned text 120-1, 122-1 and to audio segment 110-1. In one embodiment, each segment corresponds to a thought or sentence in the presentation. In another embodiment, each segment corresponds to a unit of time in the media file.

By processing the original audio for animation 130 and audio 110 into segments and by providing the closed-captioned text 120, 122 as blocks of text, each audio segment 110-1 can be associated with a respective media segment(s), such as the animation segment 130-1 and block of closed-caption text 120-1 or 122-1. As discussed in more detail below, processing the audio and visual media into segments facilitates the synchronization process.

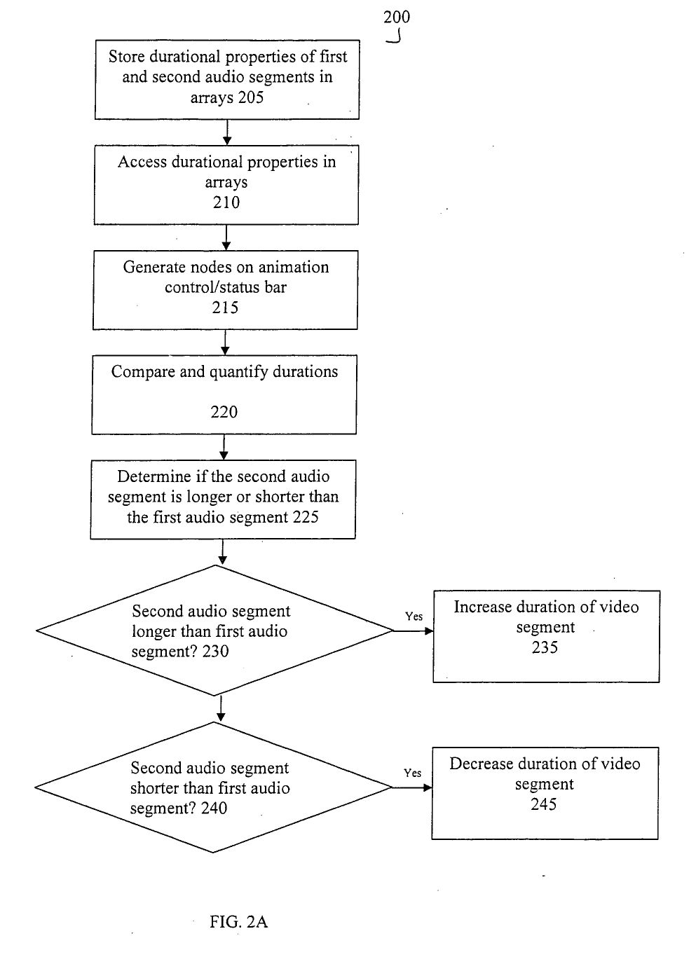

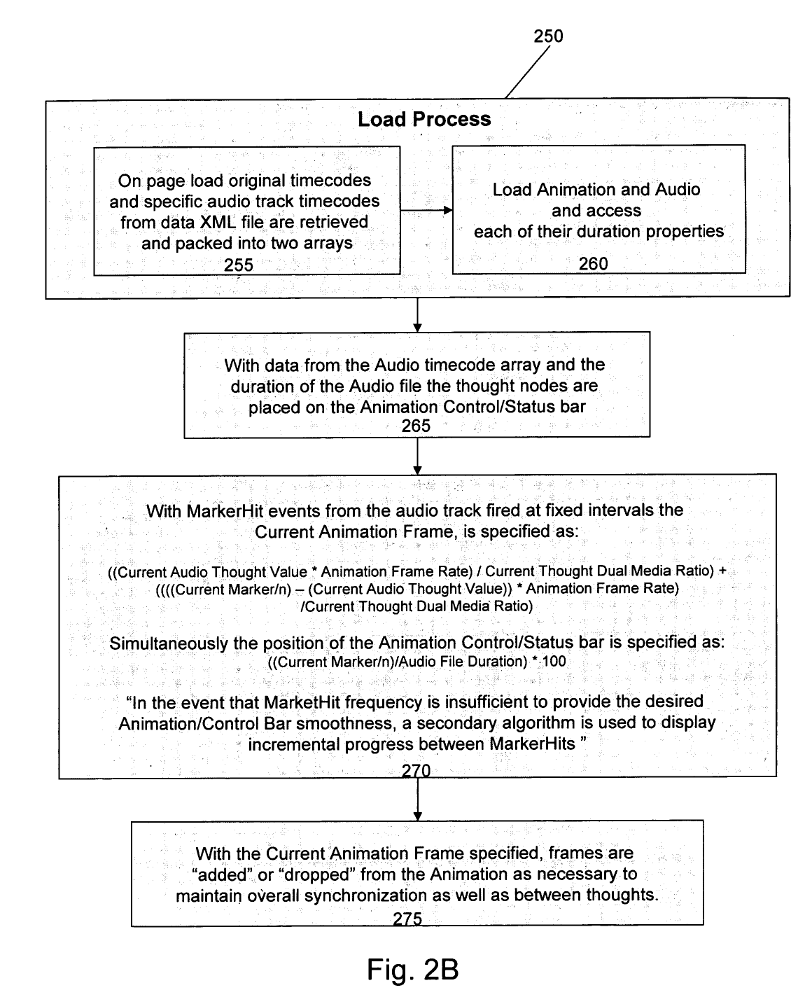

FIG. 2A is a block diagram depicting the process 200 of synchronizing media in a presentation according to an embodiment of the invention. By way of background, a developer should have already created a presentation that includes a video stream that is substantially synchronized to an initial audio stream (the “first audio”). Now, the developer may want to revise the presentation so that instead of having the first audio stream, the presentation has an audio stream in another language (the “second audio”). In order to accomplish this task with conventional time-coding technology, the developer would need to substantially synchronize the video stream with the second audio. In particular, the developer would generally need to synchronize to the second audio even though the presentation was previously synchronized with the first audio. With the invention, however, changes to the media and audio streams in a presentation can be made and the content of presentation can still be substantially synchronized. These changes can occur at anytime (even at run-time). A viewer of the presentation can select, on the fly, that the presentation be played with in a particular language. Even though the presentation had not been previously synchronized with the audio file that corresponds to the selected language, the present process can enable synchronization to be achieved at run-time.

Before the process 200 can be invoked, the second audio is processed into segments. Each of the second audio segments corresponds to a respective video segment. When the second audio is processed into segments, the duration properties of each segment is determined. At 205, the duration properties of the first audio segments and the second audio segments are processed and each stored into arrays. At 210, the durational properties of the first and second audio segments are accessed from their respective arrays. At 215, the data from the arrays is used to generate thought nodes on the animation control/status bar.

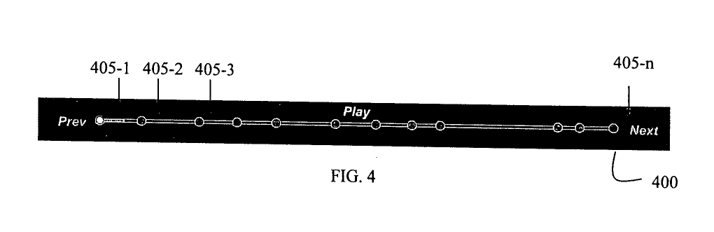

A depiction of an animation control/status bar 400 is shown in FIG. 4. The animation control/status bar 400 includes a bulls eye at the left 405-1 and right edges 405-n, as well as a bulls eye, such as 405-2, 405-3, at the boundary between each segment in the presentation. The process described in FIG. 2A can re-compute, at run-time, these points 405-1, . . . , 405-4 based on the duration properties of the first and second audio segments, and advance the progress 400 bar based on the running time of the audio.

Referring back to FIG. 2A, at 220, the process 200 compares and quantifies the duration of the second audio segment with the duration of the first audio segment. At 225, the process determines if the second audio segment is longer or shorter than the first audio segment. At 230, if the duration of the second audio segment is longer than the duration of the first audio segment, then at 235 the duration of the video file is increased. If, for example, the duration of the second audio segment is longer, say by 10%, then as the audio and video for this segment is played, every 10th video frame is repeated. At 240, if the duration of the second audio segment is shorter than the duration of the first audio segment, then at 245 the duration of the video segment is decreased. If, for example, the duration of the second audio segment is shorter, say by 20%, then as the audio and video for this sentence is played, every 5^{th} video frame is skipped. In this way, the process automatically lengthens or shortens the video, so that the audio and video complete each segment at the same time. In this way, the total number of frames in the corresponding video segment are adjusted based on the comparison. By adjusting the total number of frames in the video segment, the process 200 can enable several languages to be supported for a single animation/video.

In general, the skipping or repetition of an occasional video frame is not noticeable to the viewers. Typically, the standard frame rate in Flash animations is 12 frames per second (fps), and depending on the format, in film it is 24 fps, in television it is 29.97 fps, and in some three-dimensional games it is 62 fps. If the process 200 causes certain video frames to be dropped, the human eye is used to motion blur and would not notice a considerable difference in smoothness of the animation. Similarly, when there are 12 or more frames played in a second, and some of those frames are repeated, the repeated frames are substantially unapparent because the repetition occurs in a mere fraction of a second.

In one embodiment, when the video and audio files are processed into segments, each audio segment corresponds to a spoken sentence reflected in the audio file. The process 200 works particularly well when the sentence structures in the first language and the second language are similar. If the sentence structure of the second language used in the audio is similar to the first language, even if the sentences are substantially longer or quite shorter, then the process 200 can produce automatic synchronization. This is the case, for example, with Vietnamese and English.

If the sentence structure of the second language is different than the first language, the synchronization can not be seamless for every word; however, synchronization is maintained across sentences. The resultant synchronization is adequate for many applications. If necessary, the video for certain sentences could be reworked manually, taking advantage of the automatic synchronization for the remainder of the sentences (e.g. segments).

FIG. 2B is a block diagram depicting specific functions that occur with a dual media page load, according to an embodiment of the invention. This particular embodiment relates to an implementation using Windows Media player.

In general, a presentation is developed that includes media, such as an animation and several audio tracks. Any these audio tracks can be played with the presentation. Although the animation is initially synchronized to a first audio track at development time, at run-time the animation can be substantially synchronized to a second audio track. The animation and the first audio file are time-coded and processed into corresponding segments. The second audio file is also processed into corresponding segments. The time-coding information associated with the video and first audio streams and durational properties associated with the second audio stream, are stored in an XML file associated with the presentation.

The first and second audio tracks are processed with Microsoft's Windows Media command line encoder, which causes a new .wma audio file to be produced, respectively. Microsoft's asfchop.exe can be used to insert, hidden markers at regular intervals into the newly encoded audio file (10 markers per second, for example). At run-time, the marker events are fired at a rate of 10 times per second. A handler that is responsive to a marker event communicates with the player, in order to ensure that the video file is substantially synchronized with the second audio file. This process is discussed in more detail below, in reference to FIG. 2B.

As described in FIG. 2B, at 255, time-codes are extracted from the xml data file, specific to that page in the presentation. The time-code, durational information associated with the first audio file, and durational information associated with the second audio file, are stored in arrays. At 260, the second audio and animation files are loaded into the player. The second audio and animation files can be processed by a single player, or can have their own respective players. At 265, the thought nodes on the animation control/status bar are set-up using the time-code and duration information. At 270, with each successive marker (which triggers a MarkerHit event), the animation file is substantially synchronized to the second audio file.

The handler is responsive to the MarkerHit event, and in communication with the player. The player determines (i) the time value of the current position of the second audio track (“Current Audio Thought Value”), (ii) animation frame rate, e.g. 15 frames per second, (“Animation Frame Rate”), (iii) overall duration of first audio file and its current segment compared with the overall duration of the second audio file and its current segment (“Current Thought Dual Media Ratio”), (iv) current marker that triggered the MarkerHit event (“Current Marker”), and (v) the frame number (“n”). These values are processed using the following formula to substantially synchronize the animation with the second audio track.

$$( \frac{( \begin{matrix}CurrentAudioThoughtValue * \\ AnimationFrameRate\end{matrix} )}{CurrentThoughtDualMediaRatio} ) + \\ ( \frac{( \begin{matrix}( ( CurrentMaker / n ) - \\ ( CurrentAudioThoughtValue ) ) * \\ AnimationFrameRate\end{matrix} )}{CurrentThoughtDualMediaRatio} )$$

The animation control/status bar is also updated. The following formula is used to update the animation control/status bar.
((CurrentMarkerIn)/AudioFileDuration)*100

It should be noted that in the event that marker frequency is less than the animation frame rate, a secondary algorithm can be invoked to aesthetically “smooth” the progress of the Animation Control/Status bar.

At 275, synchronization is maintained. Thus, the time-coding process 250 allows the designer to generate two or more sets of time-codes for the same animation. This allows for the support of several language tracks for a single animation/video.

Embodiments of the invention are commercially available, such as the Automatic e-Leaming Builder™ and Automatic e-Learning Builder™, from Automatic e-Learning, LLC of St. Marys, Kans.

It will be apparent to those of ordinary skill in the art that methods involved herein can be embodied in a computer program product that includes a computer usable medium. For example, such a computer usable medium can include a readable memory device, such as a hard drive device, a CD-ROM, a DVD-ROM, or a computer diskette, having computer readable program code segments stored thereon. The computer readable medium can also include a communications or transmission medium, such as a bus or a communications link, either optical, wired, or wireless, having program code segments carried thereon as digital or analog data signals.

It will further be apparent to those of ordinary skill in the art that, as used herein, “presentation” can be broadly construed to mean any electronic simulation with text, audio, animation, video or media.

In addition, it will be further apparent to those of ordinary skill that, as used herein, “synchronized” can be broadly construed to mean any matching or correspondence. In addition, it should be understood that that the video can be synchronized to the audio, or the audio can be synchronized to the video.

While this invention has been particularly shown and described with references to preferred embodiments thereof, it will be understood by those skilled in the art that various changes in form and details may be made therein without departing from the scope of the invention encompassed by the appended claims.

1. A system for synchronizing media content comprising:
a media segment having a media duration;
a first audio segment corresponding to the media segment, the first audio segment having a first audio duration;
a second audio segment corresponding to the media segment, the second audio segment having a second audio duration; and
a processor comparing the first audio duration with the second audio duration and adjusting the media duration to substantially equal the second audio duration based on the comparison.

2. A system as in claim 1 wherein the processor comparing the first audio duration with the second audio duration further includes the processor comparing, at run-time, the media segment and first audio segment.

3. A system as in claim 1 wherein the processor comparing the first audio duration with the second audio duration and adjusting the media duration to substantially equal the second audio duration based on the comparison further includes:
a handler, in communication with the processor, responding to a determination that the duration of the second audio segment is greater than the duration of the first audio segment, by directing the processor to add one or more frames in the media segment.

4. A system as in claim 3 further including the processor, in communication with a player, adding one or more frames to the media segment to increase the duration of the media segment.

5. A system as in claim 4 wherein the player, in communication with the processor, adding one or more frames to the media segment to increase the duration of the media segment further includes the player, in communication with the processor, repeating one or more frames of the media segment.

6. A system as in claim 5 wherein the player, in communication with the processor, repeating one or more frames of the media segment further includes the player, in communication with the processor, repeating every Nth frame of the media segment.

7. A system as in claim 6 wherein the player, in communication with the processor, repeating every Nth frame of the media segment further includes:
the player, in communication with the processor, responding to a determination that the second audio duration is approximately ten percent greater than the first audio duration by causing every tenth frame of the media segment to be repeated.

8. A system as in claim 1 wherein the processor comparing the first audio duration with the second audio duration and adjusting the media duration to substantially equal the second audio duration based on the comparison further includes:
a handler, in communication with the processor, responding to a determination that the second audio duration is less than the first audio segment by removing one or more frames from the media segment by directing the processor to remove one or more frames from the media segment.

9. A system as in claim 7 wherein the processor removing one or more frames from the media segment further includes the player, in communication with the processor, causing the media duration to decrease.

10. A system as in claim 7 wherein the processor removing one or more frames to the media segment further includes the player, in communication with the processor, removing one or more frames to the media segment.

11. A system as in claim 7 wherein the processor removing one or more frames from the media segment further includes the player, in communication with the processor, dropping every Nth frame from the media segment.

12. A system as in claim 8 wherein the processor dropping every Nth frame from the media segment further includes:
the player, in communication with the processor, responding to a determination that the duration of the second audio segment is approximately twenty percent greater than the duration of the first audio segment by dropping every twentieth frame of the media segment.

13. A system as in claim 1 wherein the first audio segment is associated with an initial version of audio and the second audio segment is associated with a subsequent version of the audio.

14. A system as in claim 1 wherein the first audio segment is associated with a first language and the second audio segment is associated with a second language.

15. A system as in claim 14 wherein the first audio segment has corresponding text content in the first language, and the second audio segment has corresponding text content in the second language.

16. A system as in claim 15 wherein the text content for the first and second languages correspond to closed-captioning text for a presentation.

17. A system as in claim 16 wherein the presentation is at least one of an e-learning presentation, interactive exercise, video, animation, or movie.

18. A system as in claim 16 wherein the presentation is created using developer tools, which include an electronic table having rows and columns defining cells.

19. A system as in claim 18 wherein the developer tools for creating the presentation further include:
a time-coder in communication with the electronic table;
the time-coder being responsive to a request to assign time-coding information to a respective media stream, audio stream, or text content; and
the electronic table, in communication with the time-coder, storing identifiers that reflect the time-coding information assigned by the time-coder.

20. A system as in claim 19 wherein the time-coding information controls playback duration of the respective media stream, audio stream, or text content in the presentation.

21. A system as in claim 18 wherein the electronic table enables a user to specify electronic content for a presentation.

22. A system as in claim 21 wherein the electronic content for the presentation is specified in the cells of the electronic table.

23. A system as in claim 22 wherein the electronic content includes media content, audio content or text content.

24. A system as in claim 21 wherein the developer tools further include:
a builder engine processing time-codes specified in the electronic table;
the builder engine generating computer readable instructions based on the time-codes; and
the computer readable instructions defining the presentation.

25. A system as in claim 24 wherein the computer readable instructions are stored in an XML file.

26. A system as in claim 24 wherein the computer readable instructions cause the player to create an array referencing information about the electronic content in an array.

27. A system as in claim 26 wherein the array further includes cells that substantially reflect the arrangement of the cells in the electronic table.

28. A system as in claim 1 wherein the processor adjusting the media duration to substantially equal the second audio duration based on the comparison further includes adjust the media duration without modifying any content stored in the media segment.

29. A system as in claim 1 wherein the media duration is the same as the first audio duration before the processor adjusts the media duration to substantially equal the second audio duration.

30. A system as in claim 1 wherein the media duration reflects the first audio duration before the processor adjusts the media duration to substantially equal the second audio duration further includes:
time-codes associated with the media segment and the first audio segment, where the media segment is substantially synchronized with the first audio segment.

31. A system as in claim 1 wherein the media segment is adjusted to substantially equal the second audio segment without any time-code information associated with the second audio segment.

32. A system as in claim 1 further including:
a media stream having a plurality of media segments, where one of the segments is the media segment;
a first audio stream having a plurality of segments, where one of the segments is the first audio segment; and
a second audio stream having a plurality of segments, where one of the segments is the second audio segment.

33. A system as in claim 1 wherein the processor adjusting the media duration to substantially equal the second audio duration based on the comparison further includes the processor automatically adjusting the media duration.

34. A method for synchronizing media and audio comprising:
processing a media segment and a first audio segment, the media segment having a duration that corresponds to the duration of the first audio segment;
comparing the duration of the first audio segment with a duration of a second audio segment; and
causing the duration of media segment and the duration of the second audio segment to correspond by modifying the duration of the media segment based on the comparison.

35. A method as in claim 34 wherein comparing the duration occurs at run-time.

36. A method as in claim 34 wherein modifying the duration of the media segment based on the comparison further includes:
determining that the duration of the second audio segment is greater than the duration of the first audio segment; and
responding to determining that the duration of the second audio segment is greater than the duration of the first audio segment by adding one or more frames to the media segment.

37. A method as in claim 36 wherein adding one or more frames to the media segment further includes increasing the duration of the media segment.

38. A method as in claim 36 wherein adding one or more frames to the media segment further includes copying one or more frames to the media segment.

39. A method as in claim 36 wherein adding one or more frames to the media segment further includes repeating one or more frames of the media segment.

40. A method as in claim 39 wherein repeating one or more frames of the media segment further includes repeating every Nth frame of the media segment.

41. A method as in claim 40 wherein repeating every Nth frame of the media segment further includes:
determining that the duration of the second audio segment is approximately ten percent greater than the duration of the first audio segment; and
repeating every tenth frame of the media segment.

42. A method as in claim 34 wherein modifying the duration of the media segment based on the comparison further includes:
determining that the duration of the second audio segment is less than the first audio segment by removing one or more frames from the media segment; and
responding to determining that the duration of the second audio segment is less than the first audio segment by removing one or more frames from the media segment.

43. A method as in claim 42 wherein removing one or more frames from the media segment further includes decreasing the duration of the media segment.

44. A method as in claim 42 wherein removing one or more frames from the media segment further includes removing one or more frames from the media segment.

45. A method as in claim 42 wherein removing one or more frames from the media segment further includes dropping every Nth frame from the media segment.

46. A method as in claim 45 wherein dropping every Nth frame from the media segment further includes:
determining that the duration of the second audio segment is approximately twenty percent greater than the duration of the first audio segment; and
dropping every twentieth frame of the media segment.

47. A method as in claim 34 further including:
defining the media segment using time-codes, where the media segment reflects a portion of a media stream, the media stream being portioned into segments with time-codes;
defining the first audio segment using time-codes, where the first audio segment reflects a portion of a first audio stream being substantially synchronized to the media stream, the first audio stream being partitioned into segments using time-codes; and
defining the second audio segment using markers, where the second audio segment reflects a portion of a second audio stream corresponding to the media stream and the first audio stream, the second audio stream being segmented using markers.

48. A method as in claim 14 wherein defining the media segments and first and second audio segments using the time-codes further includes:
processing the first and second audio streams by inserting markers at each respective segment; and
responding to the markers by firing an event.

49. A method as in claim 48 wherein the markers are used in comparing the duration of the first audio segment with the duration of the second audio segment.

50. A method as in claim 47 wherein the first audio stream is associated with an initial version of an audio component for the media stream and the second audio stream is associated with a subsequent version of an audio component for the media stream.

51. A method as in claim 47 wherein the first audio stream is associated with a first language and the second audio stream is associated with a second language.

52. A method as in claim 51 wherein the first audio stream has corresponding text content in the first language, and the second audio stream has corresponding text content in the second language.

53. A method as in claim 52 wherein the respective text content for the first and second languages provide closed-captioning text associated with the media stream for a presentation.

54. A method as in claim 53 wherein the presentation is at least one of an e-learning presentation, interactive exercise, video, animation, or movie.

55. A method as in claim 53 wherein at least a portion of the presentation includes a combination of media content selected from a group consisting of: the media segment, the first audio segment, the text content of the language of the first audio segment, the second audio segment, the text content of the second audio segment.

56. A method as in claim 53 further includes creating the presentation using an electronic table having rows and columns defining cells.

57. A method as in claim 56 wherein creating the presentation using an electronic table further includes specifying, in the electronic table, indicators identifying respective time-codes for the media stream, the text content, and the first audio stream and the second audio streams.

58. A method as in claim 57 wherein specifying, in the electronic table, the indicators further includes:
storing, in one or more arrays, the respective time-codes defining segments of the media stream, segments of the first audio stream and segments of the second audio stream; and
using the respective time-codes stored in the arrays, controlling the duration of the media stream and the second audio streams.

59. A method as in claim 34 wherein the respective duration of the media segment and the first and second audio segments correspond to time-code information used to synchronize the media segment with the first audio segment or second audio segment.

60. A system for synchronizing media and audio comprising:
means for processing a media segment and a first audio segment, the media segment having a duration that corresponds to the duration of the first audio segment;
means for comparing the duration of the first audio segment with a duration of a second audio segment; and
means for causing the duration of media segment and the duration of the second audio segment to correspond by modifying the duration of the media segment based on the comparison.

61. A system for synchronizing media content comprising:
a media stream having a plurality of media segments, each media segment having a respective media duration;
a first audio having a plurality of first audio segments, each of the first audio segments having a respective first audio duration;
a second audio having a plurality of second audio segments, each of the second audio segments having a second audio duration;
the second audio being substantially synchronized with the media stream;
the processor comparing the first audio duration with the second audio duration, where the processor compares each segment of the first audio stream with the corresponding segment of the second audio stream at run-time, and the processor adjusts the duration of the media stream based on the comparison.

62. A system as in claim 61 wherein the processor performs the comparison at regular intervals.

63. A system as in claim 61 wherein the processor adjusts the duration of the media stream to ensure that the media stream is substantially synchronized with the second audio stream.

64. A system for synchronizing media content comprising:
a media stream having a plurality of media segments, each media segment having a respective media duration;
a first audio having a plurality of first audio segments, each of the first audio segments having a respective first audio duration;
a second audio having a plurality of second audio segments, each of the second audio segments having a second audio duration;
the second audio being substantially synchronized with the media stream; and
the processor that automatically synchronizes the media stream to whichever audio is selected by adjusting the media duration of each segment, at run-time, to reflect the duration of the selected audio.
